(19) United States
(12) Patent Application Publication
(10) Pub. No.: US 2006/0095975 A1
(43) Pub. Date: May 4, 2006

(54) Semiconductor device

(76) Inventors: Takayoshi Yamada, Takatsuki-shi (JP); Shinzo Koyama, Takatsuki-shi (JP); Yoshihisa Kato, Otsu-shi (JP); Yasuhiro Shimada, Mukou-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/212,585

(22) Filed: Aug. 29, 2005

(30) Foreign Application Priority Data
Sep. 3, 2004 (JP) 2004-257556
Sep. 3, 2004 (JP) 2004-257555

(51) Int. Cl. H04L 9/32

(52) U.S. Cl. 726/27

(57) ABSTRACT

A semiconductor device of the present invention includes: at least one of non-volatile memory unit operable to store data; at least one of an arithmetic-logic unit operable to perform an arithmetic-logic operation using data which is stored in the memory unit and data that is inputted from outside; and an output unit operable to output a result of arithmetic-logic operation performed by the arithmetic-logic unit; wherein the memory unit, the arithmetic-logic unit, and the output unit are included in a functional block, and an output line of each of the memory unit is connected only to one of at least one of the arithmetic-logic unit.

### BACKGROUND OF THE INVENTION

(1) Field of the Invention

The present invention relates to a semiconductor device which is comprised of a logic circuit having non-volatile memory elements.

(2) Description of the Related Art

In recent years, various system large-scale integrations (LSI) have been developed to arrange non-volatile memory cores together with a large-scale logic circuit, a microcomputer, and the like, on a single chip. To realize such a system LSI at low cost and with multiple functions, it is effective to apply a method for embedding various functional blocks on a single chip to decrease the total number of chips, thereby reducing an assembling cost.

Moreover, there have recently been increased necessities of storing programs, cords, and the like into the LSI, and of storing highly confidential data such as passwords. For example, as shown in FIG. 1A, the LSI includes an input/output unit 4 and a memory unit 2 having a non-volatile memory element 1, and the non-volatile memory element 1 stores the highly confidential data. If the data is stored in a non-volatile memory such as a single flash memory, the data can be easily leaked out for cryptanalysis by disassembling the device. In order to prevent such data leakage, a method is applied to integrate a non-volatile memory and a logic circuit on a single chip by using a technique for embedding the non-volatile memory together with a microcomputer and the like on the same chip, or a multi-chip package technique for assembling a plurality of chips in a single package.

Recently, applying the above-described method, the non-volatile memory has been arranged not to be recognized as a single chip in order to prevent the data leakage for cryptanalysis. Furthermore, data input and output have been restricted in the non-volatile memory element to prohibit the data from being read and written without access rights, thereby improving tamper resistance of the data.

Examples of such a LSI in which the access to the memory element is restricted are disclosed in Japanese Patent Laid-Open No. 2000-215108 publication, and the like. FIG. 1B shows a semiconductor device disclosed in the patent document. In FIG. 1B, the semiconductor device has a structure in which data can be read out from a flash memory 6 via a tri-state buffer 4g, only when a code that is readout from the flash memory 6 matches a code that is inputted from the outside. Here, the semiconductor device has an authentication function using access rights to read out data from the non-volatile memory element.

As described above, the special command or operation is necessary to read out the data from the memory embedded in the conventional system LSI, so that it has been quite difficult to illegally read out the data without authorization.

### SUMMARY OF THE INVENTION

However, in recent years, it has become possible to monitor a data bus line by probes used for failure analysis and the like of the semiconductor device, so that it has been getting easier to perform cryptanalysis of the data in the memory using data obtained by the probing. With further developments of analyzers and analysis technologies, crimes abusing such devices and technologies would occur in the future. Especially, in recent years, IC cards have been equipped with electronic money functions, which would cause a serious problem of leakage of data such as passwords. Therefore, data protection function with high tamper resistance against such illegal data analysis performed from the outside is required.

An object of the present invention is to provide a semiconductor device which stores data into storage regions in the semiconductor device and prevents the data from being leaked to the outside, thereby achieving high tamper resistance of the stored data.

To achieve the above object, the semiconductor device according to the present invention includes: at least one non-volatile memory unit operable to store data; at least one arithmetic-logic unit operable to perform a arithmetic-logic operation using the data which is stored in the memory unit and data that is inputted from outside; and an output unit operable to output a result of an arithmetic-logic operation performed by the arithmetic-logic unit; wherein the memory unit, the arithmetic-logic unit, and the output unit are included in a single functional block, and an output line of each of the memory unit is connected only to one of the arithmetic-logic unit.

With the above structure, the data stored in the memory unit is outputted only to the arithmetic-logic unit, there is no path for outputting the data to the outside, and the arithmetic-logic result generated by the arithmetic-logic unit is outputted to the outside. Thereby, it is possible to prevent data stored in the non-volatile memory element from being leaked to the outside. Furthermore, the data stored in the memory unit is outputted only to the arithmetic-logic unit, so that, even if cryptanalysis of the data is attempted by using probes, it is impossible to monitor a data bus line thereby making it difficult to read out the data, thereby achieving high tamper resistance of the stored data.

Here, in the semiconductor device, a plurality of the memory units and a plurality of the arithmetic-logic units may form a plurality of pairs respectively, and the output unit may be operable to output an output signal based on results of the arithmetic-logic operations performed by the plurality of arithmetic-logic units. Furthermore, the plurality of pairs may be arranged at random locations in the functional block.

With the above structure, by arranging the memory units at dispersed locations, highly confidential data such as key data can be dispersedly stored in the memory units which are arranged at random locations, thereby it is possible conceal where data is stored and how the data is arranged.

Here, the memory unit may include a non-volatile memory element which stores data and a flip-flop circuit which holds the data stored in the non-volatile memory element.

Thereby, the non-volatile memory element is connected to the data hold unit in the flip-flop circuit, so that the data held in the flip-flop circuit can be stored into the non-volatile memory element. Here, the arithmetic-logic unit may be a combinational circuit. Furthermore, the arithmetic-logic unit may be any one of or any combination of an AND circuit, an OR circuit, an exclusive OR circuit, and a NOT circuit.

With the above structure, the arithmetic-logic unit is comprised of the combinational circuit whose output varies depending on input conditions, and by storing a part of the input conditions into the non-volatile memory element, it is possible to hold the output from the combinational circuit or to perform arithmetic-logic operations using the stored data.

Here, the arithmetic-logic unit may be a sequential circuit.

With the above structure, a part of the data in the sequential circuit can be stored into the non-volatile memory element, so that it is possible to hold a circuit condition at a certain time.

Here, the plurality of memory units in the plurality of pairs may be operable to store respective parts of one key data, and the plurality of arithmetic-logic units in the plurality of pairs may be operable to perform one of a single encryption process and a single decryption process. With the above structure, the key data for encryption is dispersedly stored into the non-volatile memory elements which are arranged at random locations, and only processed result of the inputted data is outputted, so that it is possible to conceal where the key data is stored. In this case, since the key data is previously stored dispersedly in the memory units which are arranged at random locations, the key data is not necessary to be inputted from the outside and is not outputted to the outside, so that the key data does not appear the output unit. Thereby, it is possible to protect the data from a technique for illegally reading out the key data by monitoring the output unit.

Here, the plurality of memory units in the plurality of pairs may be operable to store respective parts of one authentication data, and the plurality of arithmetic-logic units in the plurality of pairs may be operable to perform a single authentication process.

With the above structure, it is possible to conceal where authentication data is stored by storing the authentication data dispersedly in the memory units which are arranged at random locations.

Here, the plurality of memory units in the plurality of pairs may be operable to store respective parts of one reference data which is used as reference of comparison, the plurality of arithmetic-logic units in the plurality of pairs may be operable to perform a single comparison process, and the output unit may be operable to output a result of the comparison process performed by the circuits.

With the above structure, it is possible to conceal where the authentication data is stored by storing the authentication data dispersedly in the memory units which are arranged at random locations.

Here, the above memory units may include respective ferroelectric capacitors.

With the above structure, it is possible to reduce a cell size of the non-volatile memory element, thereby facilitating arrangement of the memory units at random locations.

Here, the memory unit may be one of a magneto-modulation memory, a phase change memory, a resistance variation memory, and an electrically rewritable memory having a floating gate electrode.

Here, the arithmetic-logic unit may be arranged just proximal to the memory unit.

With the above structure, it is possible to shorten a wire length of the data outputted from the memory unit, so that it becomes difficult to read out the data by probing.

Furthermore, in order to achieve the above object, a semiconductor device according to the present invention which is reconfigurable includes: a plurality of processing elements which are programmable and arranged in a regular array; and a control circuit operable to reprogram a first processing element group that includes processing elements which are at random locations and selected from the plurality of processing elements and a second processing element group that includes processing elements which are at random locations and at least one of which is different from the selected processing elements in the first processing element group, in order to transfer a circuit function which is programmed in the first processing element group into the second processing element group.

With the above structure, circuit functions are formed in the first and second groups of processing elements which are arranged at random locations, so that risk of data cryptanalysis without authorization by probing is low. Furthermore, the control circuit reprograms the programmed circuit function to be transferred from the first processing element group to the second processing element group, so that the data storage locations become uncertain, thereby improving security of the data. This makes it difficult to perform cryptanalysis of the data by probing and the like, thereby improving tamper resistance of the data to prevent the data from being leaked to the outside.

Here, the control circuit may be operable to transfer, every predetermined time period, the circuit function which is programmed in a current processing element group into a new processing element group, the current processing element group being regarded as the first processing element group and the new processing element group being regarded as the second processing element group. Furthermore, the predetermined time period may be a certain time period or a time period when the semiconductor device receives a certain number of accesses.

With the above structure, it is possible to change the arrangement of the circuit function every predetermined time period, thereby further improving the security of the data.

Here, each processing element may include a connection circuit and a plurality of non-volatile memory elements for hold the configuration data for programming the processing element, and the control circuit may be update the configuration data of the processing element belong to the first and second processing element groups.

Here, the configuration data may include: arithmetic-logic data for determining an arithmetic-logic operation used in the arithmetic-logic circuit; and a connection data for determining a connection relationship by the connection circuit.

With the above structure, it is also possible to dispersedly arrange the configuration data at random locations, thereby making it further difficult to perform cryptanalysis of data by illegal data analysis.

Here, the non-volatile memory element may be a ferroelectric capacitor device.

With the above structure, by using a ferroelectric memory cell having a ferroelectric capacitor as the non-volatile memory element, it is possible to reduce a cell size of the non-volatile memory element, thereby facilitating the dispersed arrangements of the non-volatile memory elements at random locations in the logic circuit. Especially when, by using a ferroelectric capacitor having a structure in which a ferroelectric film as the non-volatile memory element is interposed between electrodes, the data is stored by polarization of the ferroelectric film, a process for manufacturing the ferroelectric capacitor has a high affinity for a process for manufacturing CMOS, so that it is possible to embed the ferroelectric capacitors together with the general CMOS transistors in the same block. Furthermore, a CMOS library can be utilized, thereby achieving high design flexibility.

Here, the processing element may include: a non-volatile memory element for holding specific data; a flip-flop element which is connected to the non-volatile memory element and holds the specific data.

With the above structure, the specific high confidential data is stored dispersedly at random locations, thereby making it difficult to analyze data without authorization.

Here, the specific data may be a part of an encryption key, and the first and second processing element groups may hold the encryption key and form a circuit for encryption or decryption.

With the above structure, it is possible to protect the key data which is used for an encryption or decryption circuit, from being analyzed without authorization.

Here, the specific data may be a part of an authentication data, and the first and second processing element groups may hold the authentication data and form a circuit for the authentication.

With the above structure, it is possible to protect the authentication data from being analyzed without authorization.

Further, a method for reconfiguring a semiconductor device which includes a control circuit and a plurality of programmable processing elements which are regularly arranged in a processing element array and each of which has a plurality of non-volatile memory elements, the method includes: specifying, by the control circuit, a circuit function that is included in a first processing element group, the first processing element group including processing elements which are at random locations and selected from the plurality of processing elements, and transferring, by the control circuit, the specified circuit function into a second processing element group, the second processing element group including processing elements which are at random locations and at least one of which is different from the selected processing elements in the first processing element group.

Furthermore, a method for programming a reconfigurable semiconductor device which includes a plurality of processing elements which are arranged in an array and each of which has a plurality of non-volatile memory elements, the method includes: selecting a processing element group that includes processing elements which are at random locations and selected from the plurality of processing elements; and transferring a circuit function into the selected processing element group.

As described above, according to the semiconductor device of the present invention, by storing specifically important data dispersedly into the memory units which are arranged at random locations in the semiconductor device, it is possible to achieve a significant efficiency such as for storing data with high security.

Furthermore, the circuit functions are dispersedly arranged at random locations in the processing element array, thereby arranging the data to be stored at random locations, which makes it difficult to recognize the data storage location and to perform cryptanalysis of the data without authorization.

Compared to the conventional method for gathering memory cores in a region which is separated from the logic circuit, the present invention enables to store and read out the data at a high speed. Further, when a range where the data is handled is limited, it is not necessary, in a chip, to use complicated wiring of data lines and the like that are drew from the memory core region, in order to handle the data, but the wiring can be shortened only around the logic circuit, which makes it difficult to recognize the data locations, thereby reducing the risk of the data leakage.

Furthermore, the semiconductor device can be comprised of a circuit implemented on a field programmable gate array (FPGA) by which a logic structure of the circuit can be programmed to be changed, for example, thereby achieving more flexible circuit structure, which makes it difficult to recognize the data storage locations without cryptanalysis of the program. Still further, by using the ferroelectric memory stored in the program, it is possible to arrange the memory just proximal to the logic part, so that the risk of the program analysis can be significantly reduced more than when the memory is an external memory such as a flash memory.

### FURTHER INFORMATION ABOUT TECHNICAL BACKGROUND TO THIS APPLICATION

Japanese Patent application No. 2004-257556 filed on Sep. 3, 2004 is incorporated herein by reference, and Japanese Patent application No. 2004-257555 filed on Sep. 3, 2004 is incorporated herein by reference.

### BRIEF DESCRIPTION OF THE DRAWINGS

These and the other objects, advantages and features of the invention will become apparent from the following description thereof taken in conjunction with the accompanying drawings which illustrate a specific embodiment of the invention. In the drawings:

FIG. 1A is a block diagram showing a structure of a conventional semiconductor device;

FIG. 1B is a block diagram showing a structure of another conventional semiconductor device;

FIG. 2 is a block diagram showing a structure of a logic circuit block of a semiconductor device according to the first embodiment of the present invention;

FIG. 3 is a block diagram showing another example of the structure of the logic circuit block according to the first embodiment;

FIG. 4 is a diagram showing one example of a structure in which memory units and arithmetic-logic units are arranged at dispersed locations;

FIG. 5A is a block diagram showing one example of the memory unit;

FIG. 5B is a block diagram showing one example of a structure of an non-volatile memory element;

FIG. 5C is a block diagram showing an operation timing chart of the non-volatile memory element;

FIG. 6 is a block diagram showing another example of the structure of the non-volatile memory element;

FIG. 7 is a block diagram showing when the logic circuit block is applied for an encryption process;

FIG. 8 is a block diagram showing when the logic circuit block is applied for an authentication process;

FIG. 9 is a block diagram showing a structure of a semiconductor device according to the second embodiment of the present invention;

FIG. 10 is a block diagram showing one example of a structure of PE arrays;

FIGS. 11A and 11B are diagrams showing one example of a transfer of parts of key data;

FIGS. 12A and 12B are diagrams showing one example of a transfer of circuit positions;

FIG. 13A is a block diagram showing one example of a structure of a PE;

FIG. 13B is a block diagram showing another example of the structure of the PE;

FIG. 14 is a block diagram showing an arrangement in the PE shown in FIG. 13A;

FIG. 15 is a block diagram showing in more detail a circuit structure of the PE in FIG. 13A;

FIG. 16 is a block diagram showing a structure of a switch;

FIG. 17 is a flowchart showing a transfer process by a control circuit; and

FIG. 18 is a flowchart showing a process for programming the semiconductor device.

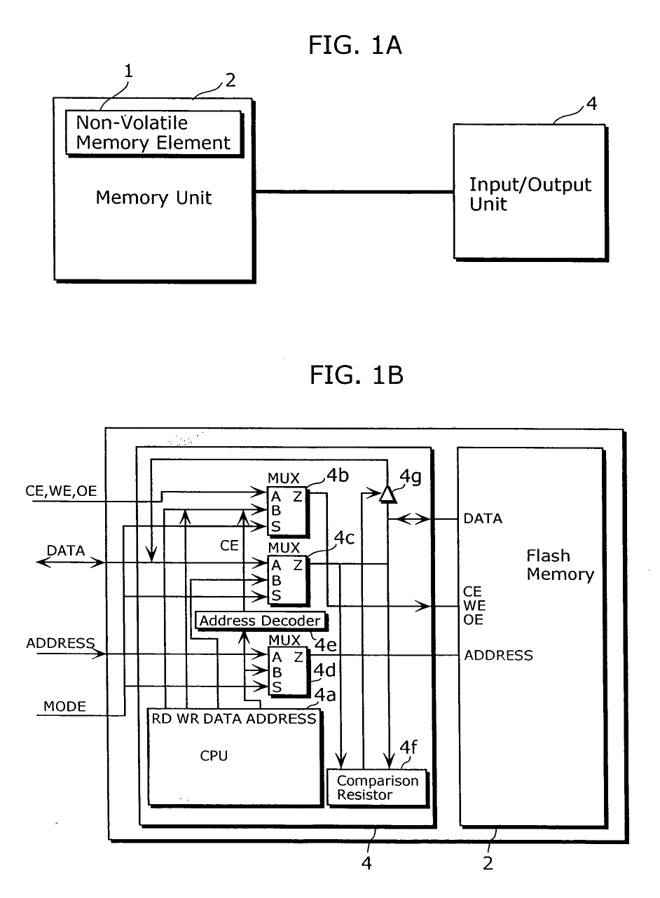

### DESCRIPTION OF THE PREFERRED EMBODIMENT(S)

### First Embodiment

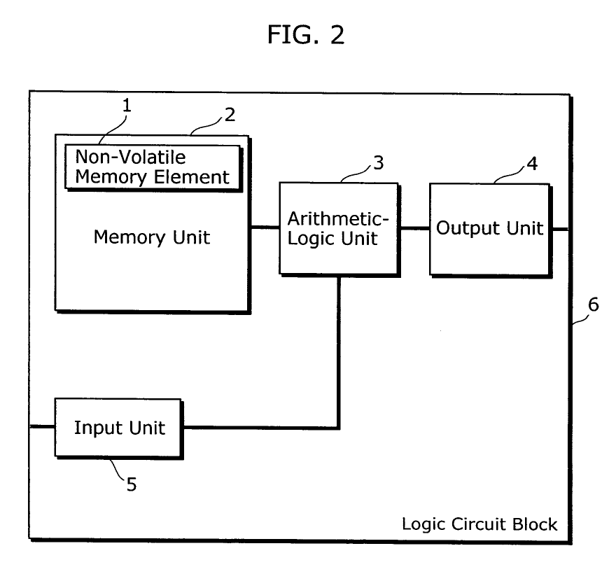

FIG. 2 is a block diagram showing a structure of a logic circuit block in a semiconductor device according to the first embodiment of the present invention. A logical circuit block 6 in the semiconductor device according to the first embodiment of the present invention is comprised of: a non-volatile memory unit 2 that has a non-volatile memory element 1 for storing data; an arithmetic-logic unit 3 that performs arithmetic-logic operations using data stored in the memory unit 2 and data inputted from the outside via an input unit 5; and an output unit 4 that outputs an arithmetic-logic result generated by the arithmetic-logic unit 3, all of which are integrated as a single functional block. Here, an output line of the memory unit 2 is connected only to the arithmetic-logic unit 3.

With the above structure, the data stored in the memory unit 2 is outputted only to the arithmetic-logic unit 3, there is no path for outputting the data stored in the memory unit 2 to the outside, and an arithmetic-logic result generated by the arithmetic-logic unit 3 is outputted to the outside. Thereby, it is possible to prevent data stored in the non-volatile memory element 1 from being leaked to the outside. Furthermore, since the data stored in the memory unit 2 is outputted only to the arithmetic-logic unit 3, even if the data is attempted to be read out for cryptanalysis by probing, it is impossible to monitor the data bus line thereby making it difficult to read out the stored data, so that high tamper resistance of the stored data can be achieved.

More specifically, by arranging the arithmetic-logic unit 3 just proximal to the memory unit 2, it is possible to shorten a wire length of the data outputted from the memory unit 2, so that it becomes further difficult to read out the data by probing. For example, the wire length of the data is preferably not more than one hundred times as large as a design minimum size.

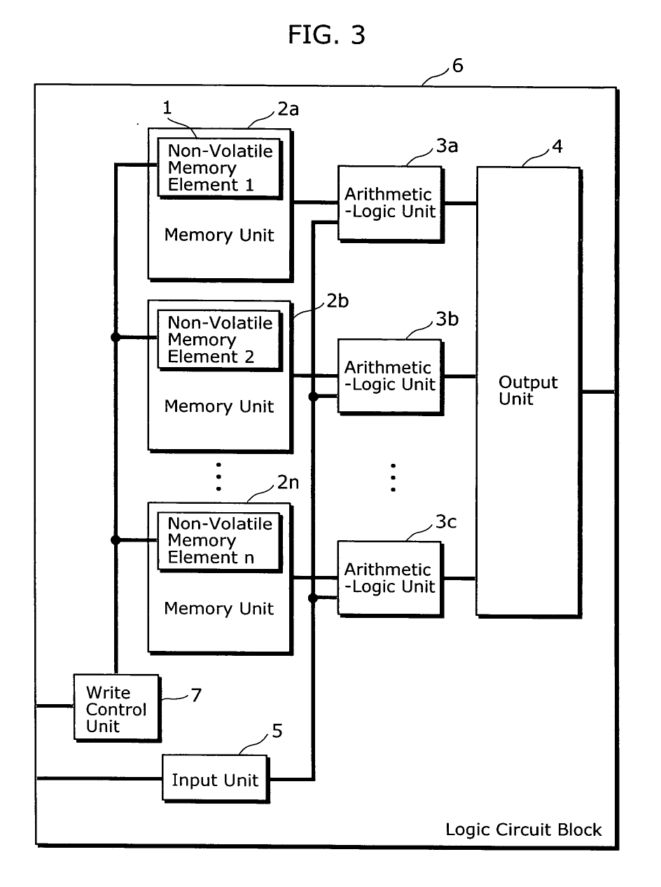

FIG. 3 is a block diagram showing another example of the structure of the logic circuit block in the semiconductor device according to the first embodiment of the present invention. In FIG. 3, the memory unit 2 and the arithmetic-logic unit 3 shown in FIG. 2 are paired, and there are a plurality of such pairs in the logic circuit block. The logic circuit block 6 is comprised of: n memory units 2a, 2b, . . . , 2n; n arithmetic-logic units 3a, 3b, . . . 3n; the output unit 4; the input unit 5; and a write control unit 7.

The memory unit 2a and the arithmetic-logic unit 3a form a pair. The memory unit 2a has a non-volatile memory element in which one bit data is written by the write control unit 7, and outputs the stored data to the arithmetic-logic unit 3a. Here, an output line of the memory unit 2a is connected only to the arithmetic-logic unit 3a. Thereby, it is possible to prevent the data stored in the memory unit 2a from being leaked to the outside. The non-volatile memory element stores one-bit data which is a part of n-bit authentication data.

The arithmetic-logic unit 3a is arranged just proximal to the memory unit 2a, and performs arithmetic-logic operations using the data outputted from the memory unit 2a and data outputted from the input unit 5. In the operation, when the logic circuit block is aimed for an authentication process, for example, data to be authenticated is inputted from the input unit 5 to each arithmetic-logic unit by one bit each, and the arithmetic-logic unit judges whether or not the data to be authenticated matches the authentication data, by using an exclusive OR operation, for example.

The memory unit 2b and the arithmetic-logic unit 3b, . . . , the memory unit 2n and the arithmetic-logic unit 3n form pairs respectively.

The output unit 4 generates an output signal based on the arithmetic-logic result of each arithmetic-logic unit, and outputs the output signal. When the logic circuit block is aimed for the authentication process, for example, the output signal is an arithmetic-logic result generated by all arithmetic-logic units using an OR operation. More specifically, when the arithmetic-logic results generated by all arithmetic-logic units are 0 (match), the output unit 4 outputs an authentication result indicating 0 (match).

The write control unit 7 controls to write data in the non-volatile memory element in each memory unit.

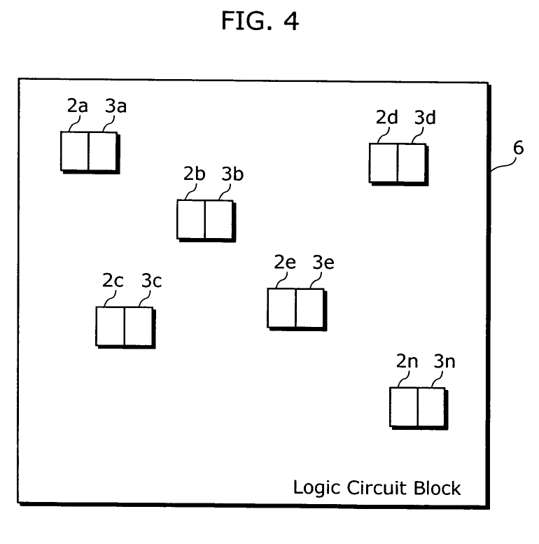

FIG. 4 is a diagram showing one example of the structure in which a plurality of pairs are arranged at dispersed locations. FIG. 4 is a schematic diagram showing a physical layout in the logic circuit block in the semiconductor device. As shown in FIG. 4, the respective pairs are dispersedly arranged at random locations. This can conceal where the data is stored and how the data is arranged.

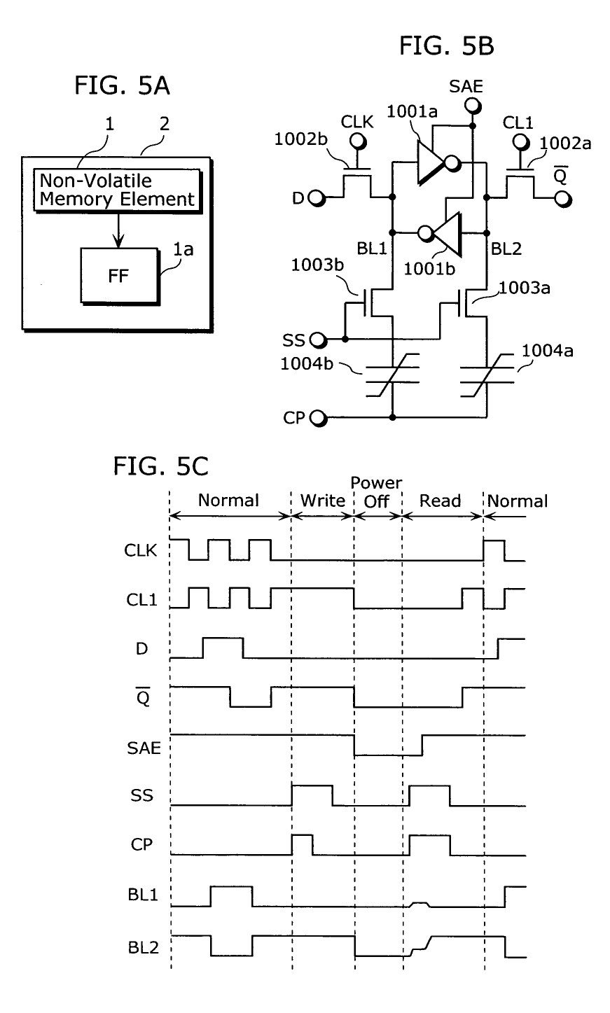

FIG. 5A is a block diagram showing one example of the memory unit. The memory unit 2 in FIG. 5A is comprised of the non-volatile memory element 1 and a flip-flop (hereafter, referred to as FF) 1a. The FF 1a improves a signal level by holding data outputted from the non-volatile memory element 1. It is also possible to write the data held in the FF 1a into the non-volatile memory element 1 under the control of the write control unit 7.

FIG. 5B shows one example of a circuit structure of the memory unit 2. The memory unit 2 in FIG. 5B is comprised of inverters 1001a and 1001b, transistors 1002a, 1002b, 1003a, and 1003b, and ferroelectric capacitors 1004a and 1004b. A latch circuit which is comprised of the two inverters 1001a and 1001b forms the FF, and output from the latch circuit is controlled by a control signal SAE. One end of the FF is connected to a bit line BL1, while the other end of the FF is connected to an inverted bit line BL2. The transistors 1002a and 1002b can be switched on/off by a clock signals CL 1 and CLK, respectively. The transistors 1003a and 1003b can be switched on/off by a control signal SS. The ferroelectric capacitors 1004a and 1004b form the non-volatile memory element 1. Respective ends of the ferroelectric capacitors 1004a and 1004b are connected to the transistor 1002a and 1002b respectively, while the respective other ends of the ferroelectric capacitors 1004a and 1004b are connected to a control signal line CP.

FIG. 5C is an operation timing chart of the memory unit 2 shown in FIG. 5B. In FIG. 5B, operations are divided into: “Normal” representing a normal operation without access; “Write” representing a write operation to write data into the ferroelectric capacitors 1004a and 1004b; “Power Off” representing when power is off; and “Read” representing a read operation.

In the normal operation “Normal”, when the SS signal is ‘low’, the transistors 1003a and 1003b are switched off, and the FF operates as a normal D flip-flop. This means that the FF latches the data of the input terminal D in synchronization with the clock signal CLK, and the FF also outputs the data from an output terminal \overline{Q} (inverting output of Q) in synchronization with the clock signal CL 1.

In the write operation “Write”, under the control of the write control unit 7, the clock signal CLK becomes ‘low’ and the clock signal CL1 becomes ‘high’, so that the transistor 1002b is switched off and the transistor 1002a is switched on. Here, the FF holds data inputted from the write control unit 7 into the terminal \overline{Q} or the data previously held in the FF, voltages of both ends of the FF are applied to the ferroelectric capacitors 1004a and 1004b via the transistors 1003a and 1003b which are switched on by the signal SS, and the signal CP becomes ‘low’, so that the data is written in the ferroelectric capacitors 1004a and 1004b.

When power is off, “Power Off”, the ferroelectric capacitors 1004a and 1004b hold the written data.

In the read operation “Read”, the level of the clock signal CLK and the clock signal CL1 are ‘low’, while the signal SS and the signal CP are ‘high’, so that the data (potential difference by polarization) held in the ferroelectric capacitors 1004a and 1004b is inputted into both ends of the FF, and the data is held in the FF. When the clock signal CL1 became ‘high’, the data in the FF (BL2) is outputted from the \overline{Q}.

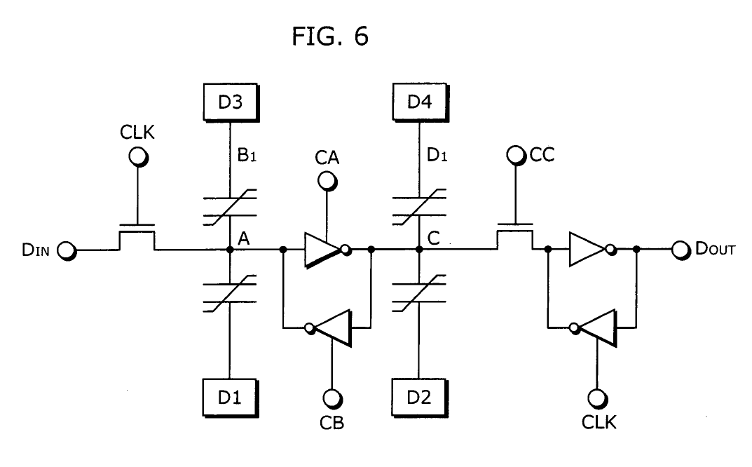

FIG. 6 is a block diagram showing another example of the circuit structure of the memory unit. The memory unit in FIG. 6 differs from the memory unit in FIG. 5B mainly in that two ferroelectric capacitors connected to terminals D3 and D4 are added and that inverter circuits are connected to an output terminal Dout. The following mainly describes those differences. The two ferroelectric capacitors connected to the terminals D3 and D4, which are arranged in parallel to two ferroelectric capacitors connected to the terminals D1 and D2, do not serve as the non-volatile memory element, but serve as load capacitances of the two ferroelectric capacitors connected to the terminals D1 and D2. Polarization directions of the ferroelectric capacitors serving as the load capacitances are not inversed after data readout. This means that the polarization directions of the two load capacitances are not different from each other, after the data readout. Thereby, even if imprints of the polarization causes distortion of polarization hysteresis in the two ferroelectric capacitors connected to the terminals D1 and D2, the distortions of polarization hysteresis are small in the load capacitances, thereby achieving reliable data readout.

Note that the inverter circuits connected to the output terminal Dout are used for outputting the data using a positive logic, not a negative logic.

An application example of the semiconductor device with the above structure according to the first embodiment of the present invention is described below in more detail.

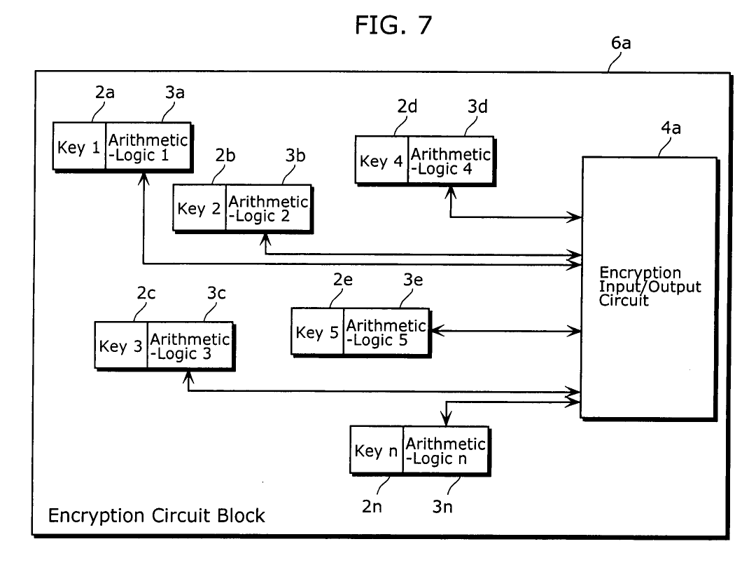

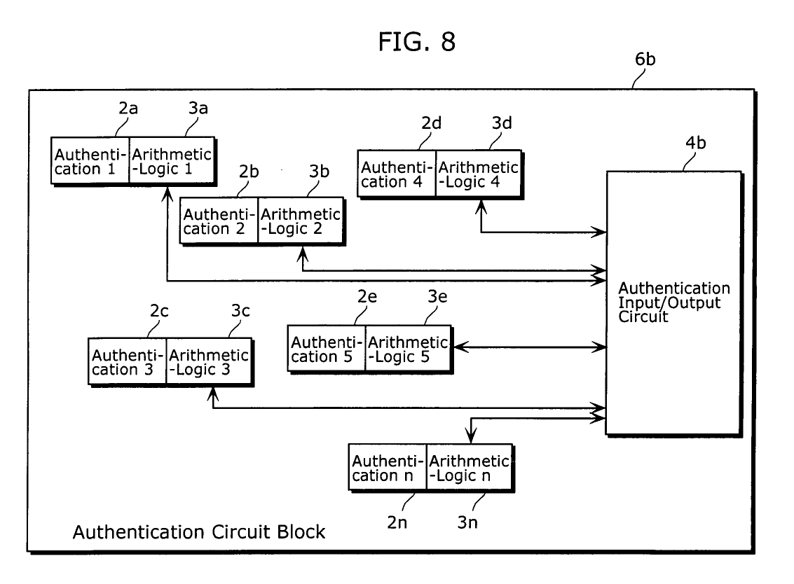

FIG. 7 is a block diagram showing when the logic circuit block is applied for an encryption process. In an encryption circuit block 6a in FIG. 7, a plurality of memory units 2a, 2b, . . . , 2n are arranged at random locations to store respective key data dispersedly. Keys 1, 2, . . . , n in FIG. 7, each of which is one bit, form n-bit key data. The plurality of arithmetic-logic units 3a, 3b, . . . , 3n form respective encryption or decryption circuits. The arithmetic-logics 1, 2, . . . , n in FIG. 7 represent respective bit arithmetic-logic functions at dispersed locations. The input/output unit 4a generates a cipher-text or a plain-text by performing bit replacement in the plain-text or the cipher-text inputted from the input unit 5 (shown in FIG. 3), or by performing bit replacement in the arithmetic-logic result generated by each arithmetic-logic unit.

As described above, the key data are dispersedly stored in a plurality of the memory units which are arranged at random locations, and the input/output unit 4a outputs only the processed result of the inputted data, which enables to conceal where the key data is stored. In this case, since the key data is previously stored in the encryption circuit block, the key data is not necessary to be inputted from the outside and is not outputted to the outside, so that the key data does not appear in the input/output unit of the encryption circuit block. Thereby, it is possible to protect the data from a technique for illegally reading out the key data by monitoring the input/output unit.

FIG. 8 is a block diagram showing when the logic circuit block is applied for an authentication process. In an authentication circuit block 6b in FIG. 8, a plurality of the memory units 2a, 2b, . . . , 2n are arranged at random locations to store authentication data dispersedly. Authentications 1, 2, . . . , n in FIG. 8, each of which is one bit, form n-bit authentication data. A plurality of the arithmetic-logic units 3a, 3b, . . . , 3n form respective authentication circuits. The arithmetic-logics 1, 2, . . . , n in FIG. 8, each of which is an arithmetic-logic such as an exclusive OR operation, are arranged at dispersed locations and compare the bits during an authentication process. The input/output unit 4a outputs data to be authenticated that is inputted from the input unit 5, into each arithmetic-logic unit dispersedly. If all arithmetic-logic results of the arithmetic-logic units are the same, then the input/output unit 4a outputs an authentication result indicating that the authenticated data is acceptable. If any one of the arithmetic-logic results generated by the arithmetic-logic units is different from another result, then the input/output unit 4a outputs an authentication result indicating that the authenticated data is unacceptable.

As described above, not only the key data, but also the authentication data is not outputted to the outside, so that the authentication data does not appear in the input/output unit. Thereby, it is possible to protect the data from a technique for illegally reading out the key data by monitoring the output unit.

### Second Embodiment

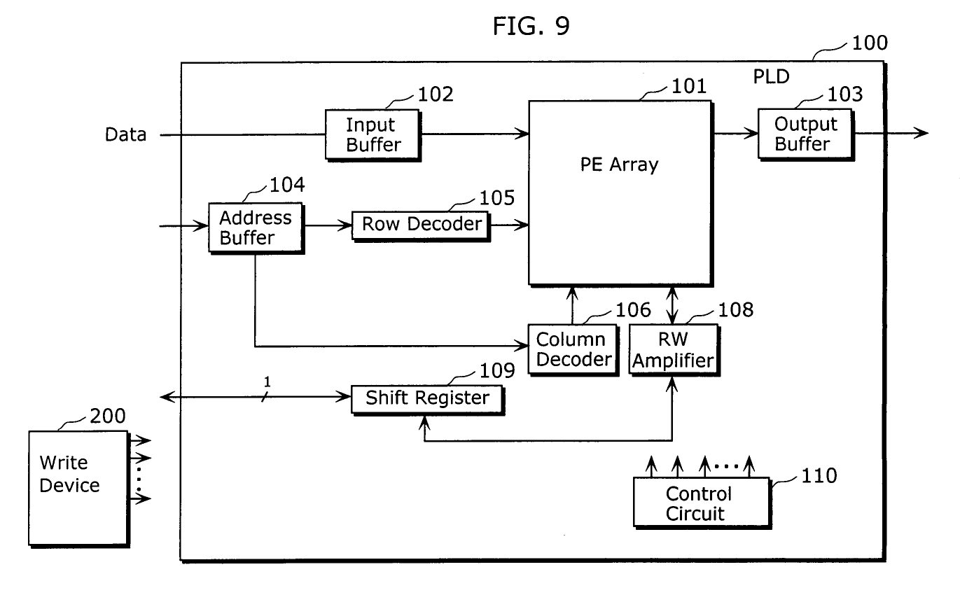

FIG. 9 is a block diagram showing a structure of a semiconductor device according to the second embodiment of the present invention. A semiconductor device 100 in FIG. 9 is comprised of an processing element array (hereafter, the processing element array will be referred to as PE array, and a processing element will be referred to as PE.) 101, an input buffer 102, an output buffer 103, an address buffer 104, a row decoder 105, a column decoder 106, a read/write amplifier (hereafter, referred to as RW amplifier) 108, a shift register 109, and a control circuit 110. The semiconductor device 100 is implemented using the FPGA by which functions in the circuit can be programmed to be changed.

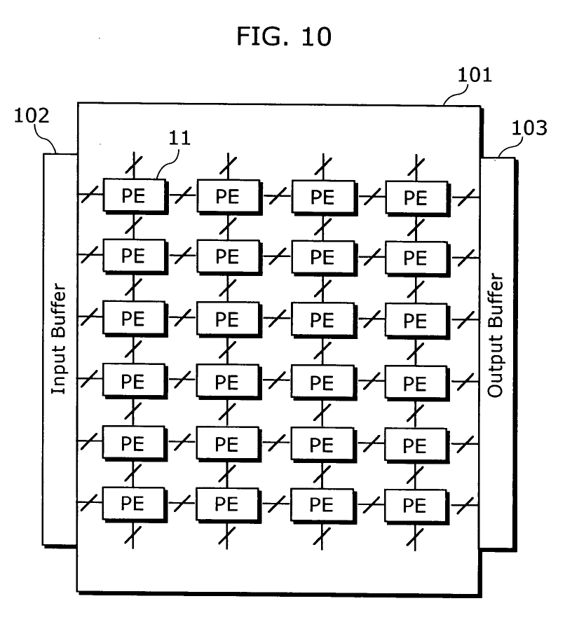

As shown in FIG. 10, the PE array 101 is comprised of a plurality of the PEs 11 which are regularly arranged on a matrix.

The following describes how to program the PE array 101. Configuration data is outputted from an external write device 200 to the RW amplifier 108 via the shift register 109. When the configuration data is outputted, an address is also outputted from the write device 200, via the address buffer 104, to the row decoder 105 and the column decoder 106. Then, a PE in the PE array 101 is selected by the row decoder 105 and the column decoder 106 to be programmed. For the programming, the write device 200 selects, in the PE array, a PE from random locations to be one group, and then programs a circuit function in each selected PE in the group. The circuit function is a combination of a data storage function, an arithmetic-logic function, and the like. Examples of such circuit functions are an encryption or decryption function, an authentication function, and the like.

The circuit functions are formed in the randomly selected PEs of the group as described above, so that the stored data are located dispersedly, thereby reducing the risk of illegal data readout by probing and the like.

The following describes how to access the PE array 101 from the outside. For example, when the PE array 101 is programmed as an encryption circuit, a plain-text is inputted from an access device such as an external microprocessor to the PE array 101 via the input buffer 102. The PE array 101 encrypts the plain-text and outputs the resulting cipher-text via the output buffer 103. When the PE array 101 is programmed as a decryption circuit, a cipher-text is inputted from an access device such as an external microprocessor to the PE array 101 via the input buffer 102. The PE array 101 decrypts the cipher-text and outputs the resulting plain-text via the output buffer 103. When the PE array 101 is programmed as an authentication circuit, data to be authenticated is inputted from an access device such as an external microprocessor to the PE array 101 via the input buffer 102. The PE array 101 authenticates the data, and outputs, via the output buffer 103, an authentication result indicating whether or not the data is acceptable. Furthermore, the control circuit 110 reprograms the circuit functions that are programmed in a PE group that is comprised of a plurality of PEs at random locations (hereafter, the current programmed group of PEs will be referred to as first PE group), to be transferred into a second PE group that is comprised of a plurality of PEs at random locations which are different from the locations of the PEs in the first PE group. Here, the reprogramming is performed every predetermined time period, for example, from several seconds to several minutes, or performed every a certain number of accesses, for example, from several times to several hundred times accesses.

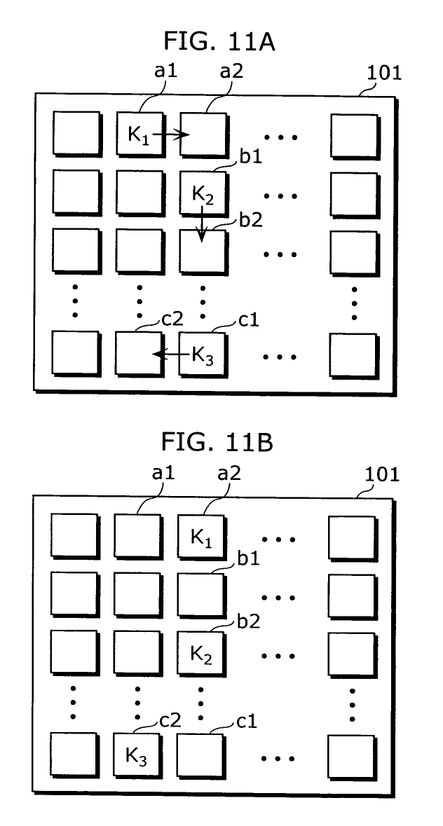

FIGS. 11A and 11B are diagrams showing one example of the transfer of the circuit functions by the control circuit 110. In FIG. 11A, a PE a1, a PE b1, and a PE c1 belong to the first PE group and hold respectively a bit K1, a bit K2, and a bit K3 which are a part of the key data. After the circuit functions in the PE a1, the PE b1, and the PE c1 are transferred by the control circuit 110, as shown in FIG. 11B, the bit K1, the bit K2, and the bit K3 of the key data are held in the PE a2, the PE b2, and the PE c2, respectively. Here, the PE a2, the PE b2, and the PE c2 belong to the second PE group.

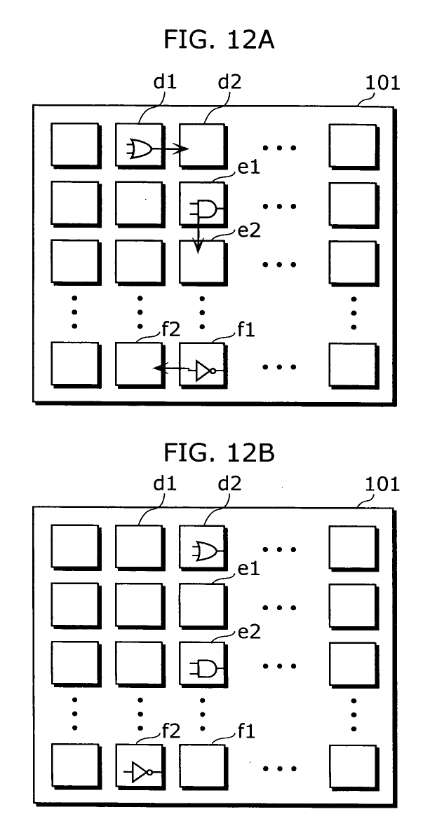

FIGS. 12A and 12B are diagram showing another example of the transfer of the circuit functions. In FIG. 12A, a PE d1, a PE e1, and a PE f1 are PEs belong to the first PE group and form respectively an OR circuit, an AND circuit, and a NOT circuit. After the circuit functions in the PE d1, the PE e1, and the PE f1 are transferred by the control circuit 110, as shown in FIG. 12B, the OR circuit, the AND circuit, and the NOT circuit are formed in the PE d2, the PE e2, and the PE f2, respectively. Here, the PE d2, the PE e2, and the PE f2 belong to the second PE group.

As described above, the control circuit 110 dynamically changes the data storage locations. For example, if the data storage locations are changed during data cryptanalysis, it is possible to dramatically improve security of the data.

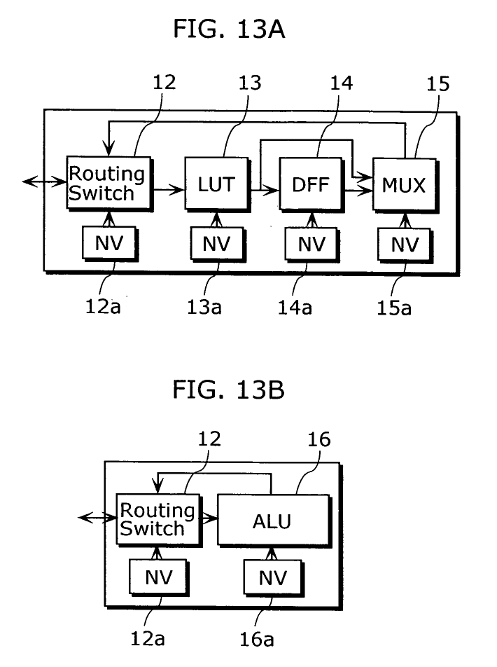

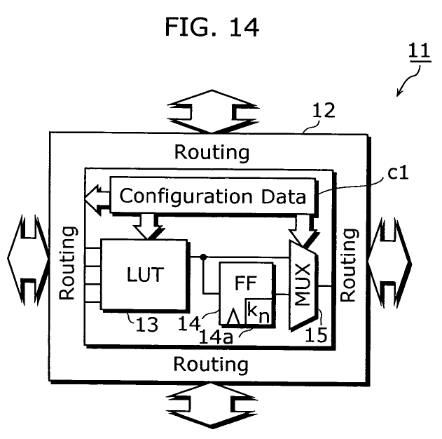

FIG. 13A is a block diagram showing one example of the structure of the PE 11 in more detail. FIG. 14 is a schematic diagram showing one example of the arrangement in the PE in FIG. 13A.

In FIGS. 13A and 14, the PE has a routing switching circuit 12, a look-up table (hereafter, referred to as LUT) 13, a D flip-flop (hereafter, referred to as DFF) 14, a multiplexer (hereafter, referred to as MUX) 15, and non-volatile memory elements 12a to 15a.

The routing switching circuit 12 is a circuit connected to other PEs. A connection relationship of the PE with other PEs is programmable and determined based on data held in the non-volatile memory element 12a.

The LUT 13 stores, as a table address, data which is inputted from the other PEs via the routing switching circuit 12, and outputs data according to the table address. The data in the LUT 13 are programmable and determined based on data held in the non-volatile memory element 13a.

The DFF 14 holds the data outputted from the LUT 13 in synchronization with a clock signal. Using the DFF 14, it is possible to select alternatively a normal FF operation in synchronization with the clock signal or a operation for holding data in the non-volatile memory element 14a.

The MUX 15 selects the output data from the LUT 13 or the output data from DFF 14, based on data held in the non-volatile memory element 15a. The selected data is outputted to other PEs via the routing switching circuit 12.

FIG. 13B is a block diagram showing another example of the structure of the PE. The structure in FIG. 13B differs from the structure in FIG. 13A in that an ALU 16 and a non-volatile memory element 16a are used instead of the LUT 13, the DFF 14, the MUX 15, the non-volatile memory elements 13a to 15a.

The ALU 16 performs an arithmetic-logic operation for data inputted from the other PEs via the routing switching circuit 12, and outputs the arithmetic-logic result to other PEs via the routing switching circuit 12. A type of the arithmetic-logic operation performed by the ALU 16 is programmable by the non-volatile memory element 16a.

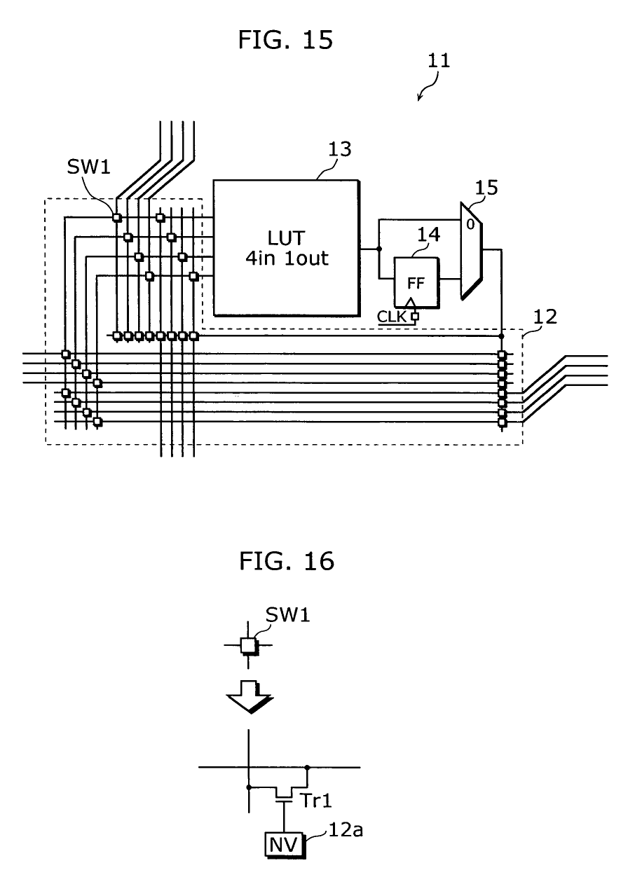

FIG. 15 is a diagram showing a circuit structure of the PE in FIG. 13A in more detail. In FIG. 15, the LUT 13 has four input ports and one output port. A connection relationship of the PE with other PEs via the routing switching circuit 12 is determined based on a switch SW1 arranged in a crossing point of connecting wires.

FIG. 16 is a schematic block diagram showing a structure of the switch SW1. A transistor switch Tr1 is arranged in a crossing point of two wires and becomes on/off based on the data held in the non-volatile memory element 12a.

One example of the circuit of the non-volatile memory element 12a in FIG. 16 is shown in FIG. 5B in more detail. FIG. 5B is also examples of the circuits of the non-volatile memory elements 13a, 15a, and 16a. Furthermore, FIG. 5B is examples of the circuits of the FF 14 and the non-volatile memory element 14a. A gate of the switch transistor Tr1 in FIG. 16 is connected directly with the terminal D or the terminal \overline{Q} in FIG. 5B.

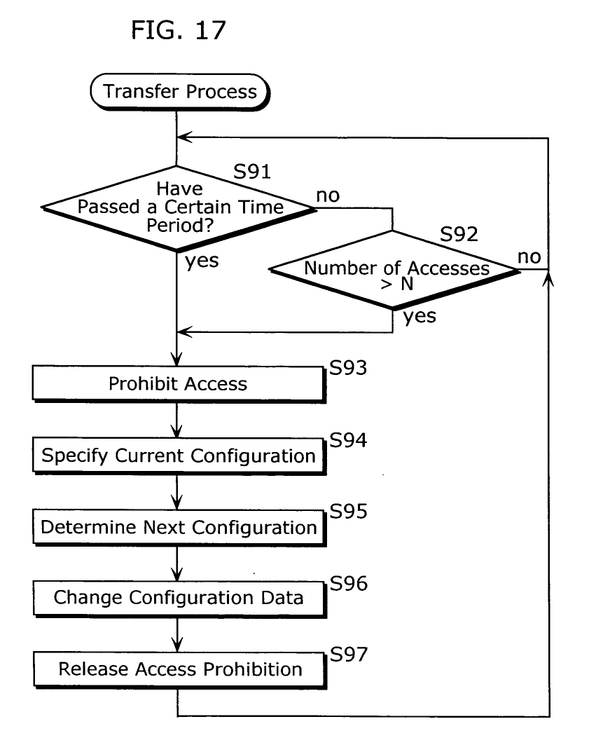

FIG. 17 is a flowchart showing the transfer process by the control circuit 110. As shown in FIG. 17, the control circuit 110 constantly judges whether or not a certain time period has been passed (S91), and whether or not the number of accesses from the outside to the semiconductor device 100 exceeds a threshold value N (S92). Here, the certain time period should be much shorter than a time period that is assumed to be necessary for performing illegal data cryptanalysis, for example, from several seconds to several minutes. Furthermore, the threshold value N should be much less than the number of accesses that is assumed to occur within the above certain time period, for example, from several times to several hundred times accesses. Note that the time period used at S91 and the number of accesses used at S92 can be changed during the process. Note also that the judgment can be made only based on the number of accesses without S91, or the judgment can be made only based on the certain time period without S92.

If the judgment is made that the certain time period has been passed, or if the judgment is made that the number of accesses exceeds the threshold value, then the control circuit 110 prohibits any access from the outside (S93), specifies a current configuration of the PE array 101 (S94), determines a next configuration based on the specified current configuration (S95), changes data of configuration of the PE array 101 (S96), and releases the access prohibition after changing the data of configuration (S97). In order to specify the current configuration, it is possible to use configuration numbers that are previously written in some PEs or the non-volatile memory elements in the control circuit 110. Furthermore, data of the next configuration may be provided as difference between the data of the next configuration and the data of the current configuration, and stored in some PEs or the non-volatile memory elements in the control circuit 110.

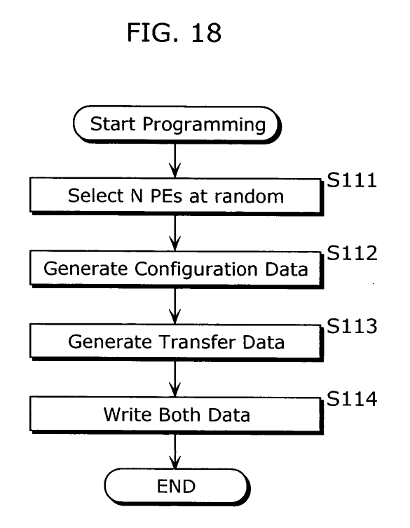

FIG. 18 is a flowchart showing a programming process by the write device 200. FIG. 18 shows a process in which the PE array 101 is programmed by writing data of a new configuration into the semiconductor device 100. The write device 200 firstly selects, from the PEs in the PE array 101, n PEs at random locations (S111), generates the first configuration data for the selected n PEs (S112), further generates transfer data which is used to transfer circuit functions in the selected n PEs into other n PEs at random locations which are different from the locations of the selected n PEs (S113), and write the data configuration and the transfer data into the PE array 101 (S114). Note that the transfer data may be the second configuration data for the other n PEs at random locations which are different from the locations of the selected n PEs, or may be difference between the first configuration data and the second configuration data. Note also that the transfer data may be a plurality of configuration data.

(Variation)

Although only some exemplary embodiments of the present invention have been described in detail above, those skilled in the art should be readily appreciate that many modifications are possible in the exemplary embodiments without materially departing from the novel teachings and advantages of the present invention. Accordingly, the following modifications are also intended to be included within the scope of the present invention.

(1) The present embodiments have been described the ferroelectric memory made of the ferroelectric substance as one example of the non-volatile memory element, but it should be appreciate that the non-volatile memory element may be an electrically erasable programmable ROM (EEPROM), a magneto-resistive random-access memory (MRAM), an ovonic unified memory (OUM), a resistance RAM (RRAM), or other types of the non-volatile memory.

(2) The present embodiments have been described the logic circuit which performs a specific process in the semiconductor device, but it should be appreciate that types of the process performed by the circuit may be changed by a software, in the same manner for a microcomputer and a FPGA.

What is claimed is:

1. A semiconductor device, comprising:
at least one non-volatile memory unit operable to store data;
at least one arithmetic-logic unit operable to perform a arithmetic-logic operation using the data which is stored in said memory unit and data that is inputted from outside; and
an output unit operable to output a result of an arithmetic-logic operation performed by said arithmetic-logic unit;
wherein said memory unit, said arithmetic-logic unit, and said output unit are included in a single functional block, and
an output line of each of said memory unit is connected only to one of said arithmetic-logic unit.

2. The semiconductor device according to claim 1,
wherein a plurality of said memory units and a plurality of said arithmetic-logic units form a plurality of pairs respectively, and
said output unit is operable to output an output signal based on results of the arithmetic-logic operations performed by said plurality of arithmetic-logic units.

3. The semiconductor device according to claim 2,
wherein said plurality of pairs are arranged at random locations in said functional block.

4. The semiconductor device according to claim 1,
wherein said memory unit includes a non-volatile memory element which stores data and a flip-flop circuit which holds the data stored in said non-volatile memory element.

5. The semiconductor device according to claim 1,
wherein said arithmetic-logic unit is one of a sequential circuit, a combinational circuit, and a combination of the sequential circuit and the combinational circuit.

6. The semiconductor device according to claim 2,
wherein said plurality of memory units in said plurality of pairs are operable to store respective parts of one key data, and
said plurality of arithmetic-logic units in said plurality of pairs are operable to perform one of a single encryption process and a single decryption process.

7. The semiconductor device according to claim 2,
wherein said plurality of memory units in said plurality of pairs are operable to store respective parts of one authentication data, and
said plurality of arithmetic-logic units in said plurality of pairs are operable to perform a single authentication process.

8. The semiconductor device according to claim 2,
wherein said plurality of memory units in said plurality of pairs are operable to store respective parts of one reference data which is used as reference of comparison,
said plurality of arithmetic-logic units in said plurality of pairs are operable to perform a single comparison process, and
said output unit is operable to output a result of the comparison process performed by said circuits.

9. The semiconductor device according to claim 1,
wherein said memory unit includes a ferroelectric capacitor.

10. The semiconductor device according to claim 1,
wherein said memory unit is one of a magneto-modulation memory, a phase change memory, a resistance variation memory, and an electrically rewritable memory having a floating gate electrode.

11. A semiconductor device which is reconfigurable, said semiconductor device comprising:
a plurality of processing elements which are programmable and arranged in a regular array; and
a control circuit operable to reprogram a first processing element group that includes processing elements which are at random locations and selected from said plurality of processing elements and a second processing element group that includes processing elements which are at random locations and at least one of which is different from said selected processing elements in said first processing element group, in order to transfer a circuit function which is programmed in said first processing element group into said second processing element group.

12. The semiconductor device according to claim 11,
wherein said control circuit is operable to transfer, every predetermined time period, said circuit function which is programmed in a current processing element group into a new processing element group, said current processing element group being regarded as said first processing element group and said new processing element group being regarded as said second processing element group.

13. The semiconductor device according to claim 11,
wherein said predetermined time period is one of a certain time period and a time period when said semiconductor device receives a certain number of accesses.

14. The semiconductor device according to claim 12,
wherein said processing element includes:
an arithmetic-logic circuit which is programmable;
a connection circuit which is programmable to connect said processing element to another processing element; and
a group of non-volatile memory elements operable to store configuration data used for programming said processing element, and
said control circuit is operable to update the configuration data of said processing element in said first processing element group and said second processing element group.

15. The semiconductor device according to claim 14,
wherein the configuration data includes:
arithmetic-logic data for determining an arithmetic-logic operation used in said arithmetic-logic circuit; and
a connection data for determining a connection relationship by said connection circuit.

16. The semiconductor device according to claim 11,
wherein said non-volatile memory element is a ferroelectric capacitor device.

17. A method for reconfiguring a semiconductor device which includes a control circuit and a plurality of programmable processing elements which are regularly arranged in a processing element array and each of which has a plurality of non-volatile memory elements, said method comprising:
specifying, by the control circuit, a circuit function that is included in a first processing element group, the first processing element group including processing elements which are at random locations and selected from the plurality of processing elements, and
transferring, by the control circuit, the specified circuit function into a second processing element group, the second processing element group including processing elements which are at random locations and at least one of which is different from the selected processing elements in the first processing element group.

18. The method according to claim 17, further comprising
transferring, by the control circuit, every predetermined time period, the circuit function which is programmed in a current processing element group into a new processing element group, the current processing element group being regarded as the first processing element group and the new processing element group being regarded as the second processing element group.

19. The method according to claim 17, comprising
transferring, every certain number of accesses, the circuit function which is programmed in a current processing element group into a new processing element group, the current processing element group being regarded as the first processing element group and the new processing element group being regarded as the second processing element group.

20. A method for programming a reconfigurable semiconductor device which includes a plurality of processing elements which are arranged in an array and each of which has a plurality of non-volatile memory elements, said method comprising:
selecting a processing element group that includes processing elements which are at random locations and selected from the plurality of processing elements; and
transferring a circuit function into the selected processing element group.
